(19) United States
(12) Patent Application Publication
(10) Pub. No.: US 2005/0088626 A1
(43) Pub. Date: Apr. 28, 2005

(54) Projection device with battery pack

(76) Inventor: Shin-Pin Huang, Taipei (TW)

Correspondence Address: Malvern U. Griffin III;SUTHERLAND ASBILL & BRENNAN LLP, 999 Peachtree Street, NE, Atlanta, GA, 30309-3996, US

(21) Appl. No.: 10/695,029

(22) Filed: Oct. 28, 2003

(51) Int. Cl. G03B 29/00

(52) U.S. Cl. 353/43

(57) ABSTRACT

A projection device with a battery pack is provided. The projection device with a battery pack includes a battery pack having a battery for providing a battery current; a converter electrically connected to the battery pack for receiving the battery current to be converted into a DC current; and a projector electrically connected to the converter and powered by the DC current.

### FIELD OF THE INVENTION

The present invention is related to a projection device, and more particularly, to a projection device with a battery pack.

### BACKGROUND OF THE INVENTION

As the computer is available to all, the peripheral devices are more and more popular. One of them is the projector. The common basic requests for a projector are portability, light-weight, and usage convenience. Nowadays, the projector is developed in the direction with compact size, light-weight, and high quality.

Presently, there are two kinds of projection devices which are classified by size: the fixed projector and the portable projector. The advantage of the fixed projector is the highly powerful function, which can project the real images of objects, films, and transparencies onto a wall. It has the function of electrical focusing and can enlarge image with steplessly adjustable value, etc. It also has multi-signal input/output, so that it can be used as a central controller. However, the disadvantages of the fixed projector are bulky size and heavy weight. Besides, it also needs additional data input devices to be the data sources when using. And a fixed projector with high quality usually has a higher price. On the other hand, the advantages of the portable projector are the light-weight feature, and the data input device is built in with. With the exception that the portable projector can't project films and transparencies, the other functions of that can be entirely as good as the functions of a professional projector.

Unfortunately, the foregoing video projector has a lamp as a projector light source, which needs large amount of power consumption, so it still needs an AC power line to receive an AC power source for the lamp. This is inconvenient and burdensome. When a user gives a presentation, there may have troubles to connect a power line between a projector and an AC power source. In addition, there are many situations in outdoor environments where a projector is needed while there are no AC power sources available. And there is always a risk that people trip over the power line and cut the power to the projector during a presentation. Therefore, the foregoing projector with an uninterruptible power supply (UPS) device has been proposed and put into practical use. Please refer to FIG. 1, the foregoing projector with a UPS usually has a UPS 1 and the projector 2. The UPS 1 has an AC input 11, an AC-DC converter 12, a charger 13, a battery 14, a DC-AC converter 15, and an AC output 16. The AC input 11 receives an AC power source that is then transmitted to the AC-DC converter 12 for converting an AC current into a DC current, so that the charger 13 is able to charge the battery 14. The battery 14 provides a DC current to the DC-AC converter 15 for converting the DC current into an AC current, so as to provide an AC current to the AC input 21 of the projector 2 via the AC output 16. The AC-DC converter 22 receives the AC current which is then transmitted to the DC-DC converter 23 for converting the DC current into a preferred DC current which the projector lamp and system modules 24 need. Accordingly, there are two electrical conversions in the foregoing projector with a UPS. One is that the DC current provided from the battery 14 is converted into an AC current in the DC-AC converter 15. The other is that the AC current provided from the AC input 21 is converted again into a DC current in the AC-DC converter 22. It is well known that each electrical conversion between AC and DC current may lose 20% electrical energy. Since the electricity is lost in the current conversion process, the foregoing projector can't be used for a long time without connecting with an AC power source.

Therefore, how to design a projector capable of being powered by a battery for a long time has become a major problem waited to be solved in the industry.

### SUMMARY OF THE INVENTION

It is the main object of the present invention to provide a projection device with a battery pack.

It is another object of the present invention to provide a projection device without a power line, which prevents a risk that people stumble over the power line.

It is another object of the present invention to provide a projection device powered by a battery can be repeatedly used for a long time.

According to one aspect of the present invention, the projection device with a battery pack includes a battery pack having a battery for providing a battery current; a converter electrically connected to the battery pack for receiving the battery current to be converted into a DC current; and a projector electrically connected to the converter and powered by the DC current.

Preferably, the converter is a DC-DC converter.

Preferably, the converter boosts a voltage of the DC current for a lamp of the projector.

Preferably, the battery is a rechargeable battery.

Preferably, the battery pack further includes a charger for charging the battery.

Preferably, the battery charger receives one of a DC power and an AC power to charge the battery.

Preferably, the DC power comes from a power system of a car.

Preferably, the battery pack further includes a battery capacity indicator for indicating a capacity of the battery.

According to another aspect of the present invention, a projection device with a battery pack includes a battery pack having a battery for providing a battery current; a power supply receiving an AC power for providing a first DC current; a converter electrically connected to the battery pack and the power supply for receiving one of the battery current and the first DC current to be converted into a second DC current; and a projector electrically connected to the converter and powered by the second DC current.

Preferably, the converter is a DC-DC converter.

Preferably, when said power supply is electrically connected to the AC power source, the converter receives the first DC current and when the power supply is not electrically connected to the AC power source, the converter receives the battery current.

Preferably, the converter boosts a voltage of the second DC current supplied for a lamp of the projector.

Preferably, the battery is a rechargeable battery.

Preferably, the battery pack further includes a charger for charging the battery.

Preferably, the battery charger receives one of a DC power and an AC power to charge the battery.

Preferably, the DC power comes from a power system of a car.

Preferably, the battery pack further includes a battery capacity indicator for indicating a capacity of the battery.

Preferably, the power supply is positioned on the projector.

The foregoing and other features and advantages of the present invention will be more clearly understood through the following descriptions with reference to the drawings, wherein:

### BRIEF DESCRIPTION OF THE DRAWINGS

FIG. 1 illustrates a projection device with a UPS in accordance with a preferred embodiment of the prior art;

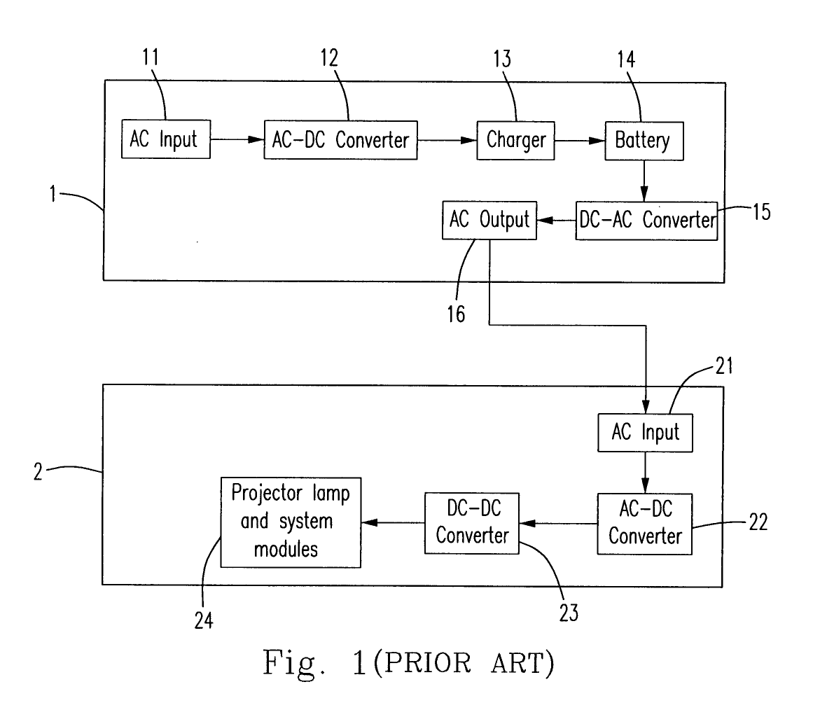

FIG. 2 illustrates a projection device with a battery pack according to a preferred embodiment of the present invention; and

FIG. 3 illustrates a block diagram of a projection device with a battery pack according to another preferred embodiment of the present invention.

### DETAILED DESCRIPTION OF THE PREFERRED EMBODIMENT

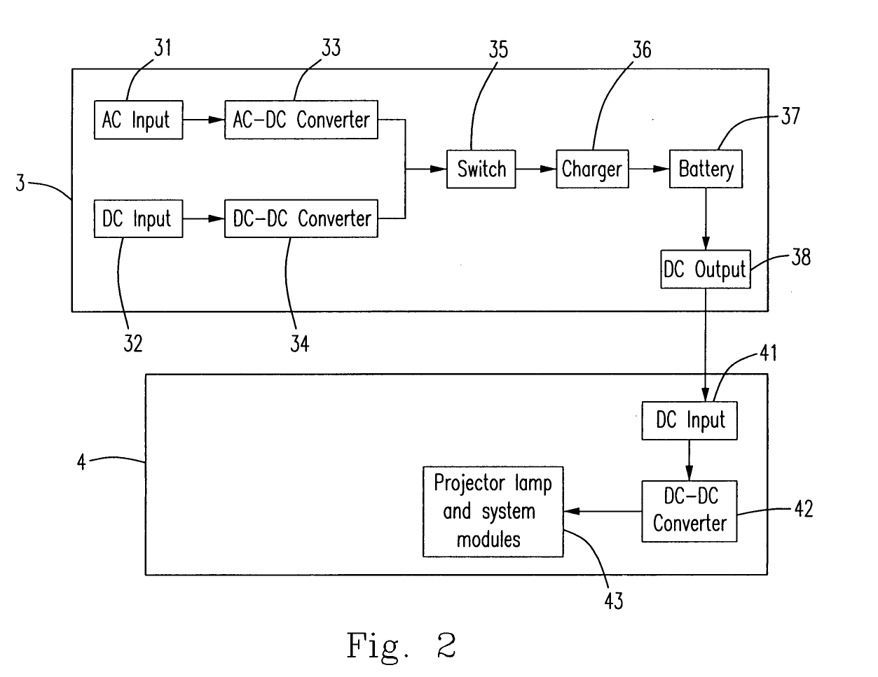

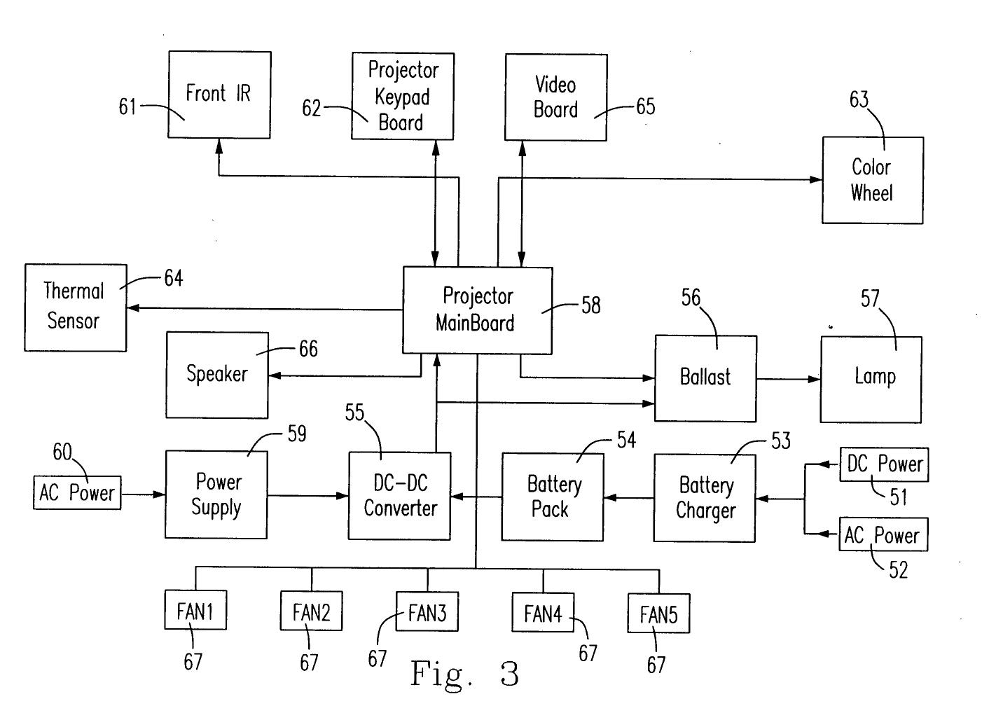

The present invention will now be described more specifically with reference to the following embodiment. Please refer to FIG. 2. FIG. 2 illustrates a projection device with a battery pack according to a preferred embodiment of the present invention. The battery pack 3 may be integrated into the projection device 4 or just electrically connected thereto. In the battery pack 3, there are two power inputs, one is the AC input 31 which receives an AC power, the other is the DC input 32 which receives a DC power. The AC current may be converted into a DC current by the AC-DC converter 33 (optional), while the DC current may be converted into a preferred DC current by the DC-DC converter 34 (optional). The switch 35 is able to switch one of the two DC currents to each other, i.e., from the AC-DC converter 33 to the DC-DC converter 34, for providing DC current to the charger 36. Then, the charger 36 charges the battery 37 for providing a battery current to the DC output 38. Meanwhile, in the projector 4, the DC input 41 receives the DC current from the DC output 38. The DC current is then transmitted to the DC-DC converter 42 to convert a preferred DC current for the projector lamp and system modules 43. % According to another preferred embodiment of the present invention as shown in FIG. 3. The battery charger 53 is switched to one of the DC power 51 and the AC power 52 for a power source, and charges the battery pack 54. The battery pack 54 provides a DC current to the DC-DC converter 55. The DC-DC converter 55 provides a preferred DC current to the projector main board 58, and boosts a high voltage current to the lamp 57 via the ballast 56. On the other hand, the DC-DC converter 55 also can be electrically connected to the power supply 59 which receives the AC power 60 for a power source. The power supply 59 converts the AC current from the AC power 60 into a DC current, and the DC-DC converter 55 can be switched to one of the currents from the battery pack 54 and the power supply 59.

Please refer to FIG. 3, again. The projector main board 58 is electrically connected to the front IR 61, the projector keypad board 62, the color wheel 63, and the thermal sensor 64 for controlling the functions of the projector. The projector main board 58 is also electrically connected to the speaker 66 and the video board 65 for outputting an audio/visual signal. The series of fan 67 are used for heat dissipating in the projector.

Additionally, the projection device of the present invention further has a battery capacity indicator for detecting and indicating a capacity of the battery. The preferred battery is a Li-Ion battery. In addition, since the projection device of the present invention can receive a DC power source to charge the battery, when the user goes outside the office to give a presentation, he can charge the battery from a power system of a car, and there is no need to find an AC power source anymore. The battery charging can be done on the road. Further, because the projection device of the present invention only has only one current conversion, that is the AC current from the battery is converted to a DC current for the projector, it can largely reduce the electricity loss and the energy consumption will be lowered. Thereby the projection device of the present invention can use battery power for a very long time without any AC power.

According to the above, because of the design of the battery pack, the present invention of the projection device can be powered simply by the battery pack as long as the battery is full of energy. So there is no need to connect a power line between the projection device and an AC power source. Even if no AC power source is provided, the projection device of the present invention can still work. Besides, the projection device of the present invention can receive a DC current for a power source, so it is easy to find a power source to charge the battery, such as the power system of a car. Finally, the present invention only has one current conversion inside the projector, so it can largely reduce the energy consumption. The cost is reduced and complicated producing process is simplified. Accordingly, the projection device of the present invention can be more weight-saving and smaller, and perform for a long time by battery power only.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation, so as to encompass all such modifications and similar structures. Accordingly, the invention is not limited by the disclosure, but instead its scope is to be determined entirely by reference to the following claims.

1. A projection device with a battery pack, comprising:
a battery pack having a battery for providing a battery current;
a converter electrically connected to said battery pack for receiving said battery current to be converted into a DC current; and
a projector electrically connected to said converter and powered by said DC current.

2. The device according to claim 1, wherein said converter is a DC-DC converter.

3. The device according to claim 1, wherein said converter boosts a voltage of said DC current for a lamp of said projector.

4. The device according to claim 1, wherein said battery is a rechargeable battery.

5. The device according to claim 4, wherein said battery pack further comprises a charger for charging said battery.

6. The device according to claim 5, wherein said battery charger receives one of a DC power and an AC power to charge said battery.

7. The device according to claim 6, wherein said DC power comes from a power system of a car.

8. The device according to claim 1, wherein said battery pack further comprises a battery capacity indicator for indicating a capacity of said battery.

9. A projection device with a battery pack, comprising:
a battery pack having a battery for providing a battery current;
a power supply receiving an AC power for providing a first DC current;
a converter electrically connected to said battery pack and said power supply for receiving one of said battery current and said first DC current to be converted into a second DC current; and
a projector electrically connected to said converter and powered by said second DC current.

10. The device according to claim 9, wherein said converter is a DC-DC converter.

11. The device according to claim 9, wherein when said power supply is electrically connected to said AC power source, said converter receives said first DC current and when said power supply is not electrically connected to said AC power source, said converter receives said battery current.

12. The device according to claim 9, wherein said converter boosts a voltage of said second DC current for a lamp of said projector.

13. The device according to claim 9, wherein said battery is a rechargeable battery.

14. The device according to claim 13, wherein said battery pack further comprises a charger for charging said battery.

15. The device according to claim 14, wherein said battery charger receives one of a DC power and an AC power to charge said battery.

16. The device according to claim 15, wherein said DC power comes from a power system of a car.

17. The device according to claim 9, wherein said battery pack further comprises a battery capacity indicator for indicating a capacity of said battery.

18. The device according to claim 9, wherein said power supply is positioned on said projector.
